(19) United States
(12) Patent Application Publication
(10) Pub. No.: US 2026/0138915 A1
(43) Pub. Date: May 21, 2026

(54) GLASSES WITH HIGH TRANSMISSION SELECTIVITY FOR 290-305 nm UV RADIATION AND VISIBLE LIGHT WHILE SUBSTANTIALLY BLOCKING OTHER WAVELENGTHS FROM SUNLIGHT AND APPLICATIONS THEREOF

(71) Applicant: Yaoxiong HUANG, Guangzhou (CN)

(72) Inventor: Yaoxiong HUANG, Guangzhou (CN)

(21) Appl. No.: 19/447,022

(22) Filed: Jan. 13, 2026

Related U.S. Application Data
(63) Continuation of application No. PCT/CN2024/119875, filed on Sep. 19, 2024.

(30) Foreign Application Priority Data
Dec. 21, 2023 (CN) 202311769598.6

(51) Int. Cl. C03C 4/08; C03C 3/089; C03C 3/095; C03C 17/09

(52) U.S. Cl. CPC C03C 4/085; C03C 3/089; C03C 3/095; C03C 4/082; C03C 17/09; C03C 2217/268; C03C 2217/74; C03C 2218/151

(57) ABSTRACT

A health-preserving and wellness glass with high transmission selectivity for beneficial 290-305 nm solar ultraviolet radiation and visible light is provided. The glass is prepared by two methods: 1) forming a multicomponent glass doped with the rare earth element Dysprosium, the glass consisting essentially of SiO₂, B₂O₃, NazO, ZnO, BaO, KO, CaO, and Sb₂O₃; or 2) providing a glass substrate of the same composition and applying a Dysprosium coating of about 0.3 μm thickness thereon. A 1 mm thickness of the glass prepared by either method exhibits 75-90% transmission for 290-305 nm UV radiation, which promotes vitamin D synthesis in the human body, and high transmission for visible light, beneficial for skin and mental wellness, while substantially blocking harmful UVB and UVA radiation and infrared radiation that causes heating sensation. This glass enables health-preserving and wellness effects from transmitted sunlight without the risks of skin tanning or overheating.

### CROSS-REFERENCE TO RELATED APPLICATIONS

This application claims priority to China Application Number 2023117695986 filed on Dec. 21, 2023 and to PCT application No. PCT/CN 2024/119875 filed on Sept. 19, 2024.

### TECHNICAL FIELD

The claimed invention relates to the field of glass material preparation, particularly to a glass that selectively transmits 290-305 nm ultraviolet radiation and visible light, while substantially blocking other wavelengths from sunlight, and its applications.

### BACKGROUND

Sunbathing is known to promote metabolism, enhance calcium and phosphorus absorption, stimulate vasodilation, increase blood flow, improve skin and tissue nutrition, and boost immunity, thereby contributing to health and delaying aging. However, sunlight comprises visible light (400-780 nm), infrared radiation (>780 nm), and ultraviolet (UV) radiation (<400 nm). In terms of total solar radiation energy, visible light accounts for approximately 50%, infrared radiation for about 43%, and ultraviolet radiation constitutes only about 7%. UV radiation is further categorized into UVC (100-280 nm), UVB (280-315 nm), and UVA (315-400 nm). Among these, far-ultraviolet radiation (UVC) is substantially absorbed by the Earth's atmosphere, with negligible ground-level incidence and thus no direct impact on the human body. In contrast, medium-wave ultraviolet (UVB) and long-wave ultraviolet (UVA) that reach the Earth's surface and irradiate the human body induce substantial physiological and biochemical responses.

The 290-305 nm band within UVB is particularly beneficial for human health, playing a critical role in maintaining human health and supporting growth and development. This specific band is primarily responsible for skeletal growth, endogenous vitamin D synthesis, and prevention of conditions such as anemia and tuberculosis. It can be stated that less than 10% of the vitamin D in the human body is derived from dietary sources, with the majority being synthesized through exposure to ultraviolet radiation within this wavelength range. Consequently, this band is often designated as the “Health Spectrum.” In contrast, other UVB wavelengths and UVA primarily cause detrimental effects such as skin burns, relaxation, aging, oxidative stress, dermatitis, potential tumorigenesis, cataracts, and immunosuppression, so, they are also referred to as the tanning spectrum. Visible light, having lower energy, generally has benign or positive effects, aside from potential pigmentary effects from its blue component and influence on circadian rhythms. Infrared radiation produces thermal effects. Far-infrared radiation (4-14 μm) can be beneficial. However, near-infrared (wavelength 780 nm-1.5 μm) and mid-infrared (wavelength 1.5-4 μm) radiation, when present at high intensities, can raise skin temperature, dilate capillaries, cause congestion, and increase epidermal water evaporation, thereby directly harming the skin. Common adverse effects include red papules, premature skin aging, and pigmentation disorders. In addition, these wavelengths may lead to symptoms such as decreased vision and corneal ulcers.

Therefore, direct sun exposure is often not recommended for sunbathing. Using transparent materials like glass that attenuate harmful UV and IR radiation is preferable. Conventional glass, however, substantially blocks UVB while transmitting UVA, which is associated with skin tanning. Thus, conventional glass structures not only fail to provide health benefits but may also pose risks.

Although some UVB-transmitting glasses have been developed, they non-selectively transmit the entire UVB spectrum, including harmful 280-290 nm and 305-315 nm radiation, and do not effectively block UVA. Consequently, the net effect approximates direct sun exposure, with significant harmful UV exposure.

There remains an unmet need for a glass that selectively and efficiently transmits the beneficial 290-305 nm UV radiation and visible light while blocking the majority of other harmful UVB, UVA, and near/mid-infrared radiation.

### SUMMARY

In order to overcome the deficiencies of the prior art, the present invention provides a glass that selectively transmits, with high efficiency, the beneficial 290-305 nm UV radiation and visible light from sunlight, while blocking the majority of harmful UVB, UVA, and near/mid-infrared radiation. The glass also converts some harmful UV radiations into beneficial visible light via a down-conversion effect, thereby enhancing the wellness effects of the transmitted light.

The present invention further discloses the applications of a glass that efficiently transmits ultraviolet light in the 290-305 nm wavelength range and visible light, while substantially blocking other wavelengths of solar radiation.

The objects of the present invention are achieved by the following technical solutions:

### Solution 1

A glass composition exhibiting high transmittance to 290-305 nm ultraviolet radiation and visible light, while substantially blocking other wavelengths of solar radiation, wherein the composition comprises, in weight percentage: SiO₂: 50-70%, B₂O₃: 10-20%, Na₂O: 10-20%, ZnO: 3-20%, BaO: 5-10%, K₂O: 1-5%, CaO: 0.1%-1%, Sb₂O₃: 0.1%-1%, and being doped with 0.5-5 mol % of the rare earth element dysprosium (Dy³⁺).

A 1 mm thick sample of the said bulk-doped glass exhibits the following optical properties: substantial blocking below 280 nm; 20-30% transmission for 280-290 nm; 80-90% transmission for 290-305 nm; 25-35% transmission for 305-400 nm; 80-90% transmission for 400-780 nm visible light; and 30-40% transmission for 790-2000 nm infrared light.

### Solution 2

The glass article comprises a glass substrate and a dysprosium-containing film layer disposed thereon.

The glass substrate has a composition consisting essentially of, by weight percent (wt. %): SiO₂: 50-70%, B₂O₃: 10-20%, Na₂O: 10-20%, ZnO: 3-20%, BaO: 5-10%, K₂O: 1-5%, CaO: 0.1%-1%, Sb₂O₃: 0.1%-1%.

The said surface dysprosium-containing film layer is deposited to a thickness in a range from 0.2 μm to 0.5 μm.

A method of manufacturing the aforementioned glass article comprises the following steps:
(1) Preparing the glass substrate with the composition detailed in paragraph [0016].
(2) Depositing a dysprosium-containing film layer onto a surface of the prepared glass substrate.

The glass article, comprising the glass substrate and the dysprosium-containing film layer with a thickness of 0.2 μm to 0.5 μm, exhibits the following optical transmission properties:
It substantially blocks light with a wavelength shorter than 280 nm.
It exhibits a light transmittance of 20% to 30% for light having a wavelength in a range from 280 nm to 290 nm.
It exhibits a light transmittance of 75% to 85% for light having a wavelength in a range from 290 nm to 305 nm.
It exhibits a light transmittance of 20% to 30% for light having a wavelength in a range from 305 nm to 400 nm.
It exhibits a light transmittance of 85% to 93% for visible light having a wavelength in a range from 400 nm to 780 nm.
It exhibits a light transmittance of 30% to 40% for infrared light having a wavelength in a range from 790 nm to 2000 nm.

### Field of Application

The glass articles according to the present invention are suitable for a variety of applications that require the selective transmission of beneficial ultraviolet radiation, which contributes to human vitamin D synthesis and wellness, along with visible light, while substantially blocking other solar wavelengths.

Exemplary applications include, but are not limited to:
Residential glass windows and skylights;
Glass ceilings and glass panels for outdoor swimming pool enclosures;
Glass enclosures for solariums or sunrooms;
Optical instruments and equipment;
Lighting apparatuses; and
Medical devices that utilize ultraviolet radiation for therapeutic purposes.

Compared with the prior art, the present invention provides the following advantages and beneficial effects:

The health-care glass disclosed herein selectively transmits, with high transmittance, both 290-305 nm mid-wave ultraviolet (UVB) radiation-which plays a vital role in the synthesis of vitamin D in the human body-and visible light, which exerts positive effects on mental well-being and skin health. At the same time, it substantially blocks other UVB and UVA wavelengths that are harmful or undesirable, as well as near-and mid-wave infrared radiation that may cause thermal-induced skin dehydration, dryness, cracking, aging, and burns.

According to the formulation of the present invention, the glass composition-comprising boron trioxide, barium oxide, silicon dioxide, and other components-enables transmission of UVB and UVA with wavelengths greater than 285 nm. Zinc oxide strongly absorbs ultraviolet radiation in the 300-400 nm range, while the rare-earth element dysprosium possesses the ability to convert ultraviolet light in the 330-460 nm range into visible light via a down-conversion effect. Through the combined action of zinc oxide and dysprosium, a majority of the harmful UVB and UVA radiation in the 305-400 nm wavelength range is blocked.

While blocking detrimental UVB and UVA radiation, the glass also enhances beneficial visible light through the down-conversion effect of dysprosium, which transforms harmful ultraviolet rays into visible light conducive to mental and dermatological wellness. Sunbathing through the health-care glass of the present invention can thus produce desirable photobiological effects.

The selectively transmitted UVB radiation in the range of 290-305 nm promotes several health benefits, including vitamin D synthesis, bone growth, and the prevention and treatment of anemia, tuberculosis, osteoporosis, and osteomalacia. It also supports growth and development in children, helping to prevent rickets. Additionally, enhanced long-wavelength visible light improves blood circulation, stimulates the production of immunoglobulins, and has a calming effect on the nerves. It increases skin elasticity, smooths wrinkles and stretch marks, and delays the aging of the skin. Moreover, harmful UVA and other harmful ultraviolet rays are substantially blocked, allowing users to avoid skin tanning and the carcinogenic risks associated with these types of radiation. Furthermore, because near-and mid-wave infrared radiations are significantly reduced, issues such as thermal discomfort, skin dehydration, erythema, premature skin aging, and pigmentation disorders caused by infrared heating effects are effectively prevented.

The health-care glass of the present invention can be widely used in the construction of sunroom enclosures, as well as in balcony, floor-to-ceiling windows, and similar applications. It serves as an effective aid for sunbathing—particularly for the elderly, pregnant women, and children—enabling convenient at-home exposure to sunlight containing beneficial ultraviolet wavelengths that stimulate vitamin D production, thereby promoting health without the drawbacks of conventional direct sun exposure, such as ultraviolet damage, tanning, and thermal discomfort.

The health-care glass of the present invention is simple to manufacture and easy to process. It exhibits good chemical stability, resistance to oxidation and aging, and high mechanical strength. Its structure is straightforward, and it demonstrates reliable stability along with resistance to oxidation and degradation. Potential applications extend beyond sunroom glazing, residential windows, and skylights to include covers for outdoor swimming pools, optical instruments and equipment requiring selective transmission of beneficial UV and visible light, medical devices used in UV-based therapies, and light-emitting apparatuses designed to emit specific wavelength ranges. The invention thus holds considerable market potential.

### DETAILED DESCRIPTION OF THE EMBODIMENTS

The following embodiments are provided to further elucidate the present invention.

### First Embodiment

A multicomponent glass doped with Dysprosium according to the present disclosure was prepared. The composition in weight percent was: SiO₂: 60%, B₂O₃: 12.8%, Na₂O: 11.2%, ZnO: 5%, BaO: 5.6%, K₂O: 4%, CaO: 0.6%, Sb₂O₃: 0.4%, doped with 3 mol % Dy³⁺ via powder addition.

The raw material powders were thoroughly mixed. The mixture was melted in a crucible at 1200° C. The melt was then pressed into plates or cast into preheated copper molds to form glass articles of various shapes.

The prepared dysprosium-doped multicomponent glass according to the present disclosure, having a thickness of 1 mm, substantially blocks light with wavelengths shorter than 280 nm. It exhibits a transmittance of 20-30% for light in the 280-290 nm wavelength range, 80-90% for the 290-305 nm range, 25-35% for the 305-400 nm range, 80-90% for visible light in the 400-780 nm range, and 30-40% for infrared light in the 790-2000 nm range.

The glass is particularly suitable for constructing various tanning glass enclosures and for installation in residential settings such as balconies and floor-to-ceiling windows. It enables users to receive beneficial solar radiation during tanning, including: adequate 290-305 nm ultraviolet light essential for stimulating vitamin D synthesis in the human body; visible light known to provide therapeutic benefits for both skin and mental health; while simultaneously blocking harmful UVB and UVA radiation that may cause skin tanning, burning, or even induce skin cancer. Furthermore, the significant attenuation of near-and mid-infrared transmission minimizes heat accumulation, thereby ensuring comfortable tanning conditions but without burning.

The glass thereby facilitates optimal bone and skin health maintenance through controlled sunlight exposure. additional therapeutic benefits include: prevention of anemia, tuberculosis, osteoporosis and osteomalacia; promotion of developmental growth in children and prevention of rickets; enhanced immunity in pregnant women and improved skeletal development of fetuses; neural system stabilization and relaxation.

The glass represents functional materials that utilize selectively transmitted solar radiation to provide healthcare, therapeutic maintenance, and wellness enhancement effects.

### Second Embodiment

A structure comprising a glass substrate and a surface Dy³⁺ coating according to the present disclosure was prepared. The glass substrate composition in weight percent was: SiO₂: 61.6%, B₂O₃: 12.8%, Na₂O: 10.2%, ZnO: 5.4%, BaO: 5.8%, K₂O: 3.2%, CaO: 0.61%, Sb₂O₃: 0.4%.

The raw material powders are thoroughly mixed, preheated at 300° C. for 20 minutes, and subsequently melted at 1200° C. The resulting melt is cast into a preheated copper mold and annealed at 400° C. for 3 hours to form a glass substrate.

A dysprosium powder is then evaporated under a vacuum or an oxygen partial pressure of 3×10⁻² Pa to 6 ×10⁻² Pa to deposit a thin film on the surface of the glass substrate. The coated substrate is further annealed in air to form a film having a thickness of 0.3 μm, thereby producing said glass which efficiently transmits ultraviolet light in the 290-305 nm range and visible light while substantially blocking other wavelengths of solar radiation.

The structure comprising the 1 mm thick substrate and the 0.3 μm Dy³⁺ coating according to the present disclosure exhibits a transmittance of 20-30% for light in the 280-290 nm wavelength range, 75-85% for the 290-305 nm range, 20-30% for the 305-400 nm range, 85-93% for visible light in the 400-780 nm range, and 30-40% for infrared light in the 790-2000 nm range.

This product highly transmits the 290-305 nm UV that is vital for vitamin D synthesis while absorbing and blocking harmful 280-290 nm UV and 305-400 nm UVA, converting them into beneficial red and yellow visible light, thereby enhancing the wellness effects of the transmitted spectrum.

The illustrated examples depict selected ways to implement the presently claimed invention. but the presently claimed invention may also be applied in a manner not covered by the above-mentioned cases. The examples are provided by way of illustration and not by restriction of the implementation of the claimed invention. Other approaches may also be applied which do not deviate from the essence and spirit of the presently claimed invention. Foreseeable changes, modifications, substitutions. combinations or simplifications can be applied as equivalent methods and are included in the presently claimed invention within the scope of protection.

### INDUSTRIAL APPLICABILITY

The invented glass according to the present disclosure enables safe sunlight exposure by transmitting health-promoting UV and visible light while minimizing risks associated with harmful radiation. Its simple preparation, stability, and versatility make it suitable for widespread applications in the construction of sunroom glazing, residential windows, and skylights to include covers for outdoor swimming pools, optical instruments and equipment requiring selective transmission of beneficial UV and visible light, medical devices used in UV-based therapies, and light-emitting apparatuses designed to emit specific wavelength ranges.

What is claimed is:

1. A glass that efficiently transmits ultraviolet light in the 290-305 nm range and visible light, while substantially blocking other wavelengths of ultraviolet radiation and a majority of infrared radiation,, characterized in that the glass comprises the components SiO₂, B₂O₃, Na₂O, ZnO, BaO, K₂O, CaO, Sb₂O₃, and the rare earth element dysprosium (Dy³⁺), and is characterized in that it is manufactured by two methods.

2. The glass according to claim 1, which efficiently transmits ultraviolet light in the 290-305 nm range and visible light while blocking other wavelengths of sunlight. characterized in that the composition of the glass comprises, by weight percentage:
SiO₂: 50-70%;
B₂O₃: 10-20%;
Na₂O: 10-20%;
ZnO: 3-20%;
BaO: 5-10%;
K₂P: 1˜5%;
CaO: 0.1%-1%;
Sb₂O₃: 0.1%-1%;
and is doped with 0.5-5 mol % of the rare earth element dysprosium (Dy).

3. The glass according to claim 2, characterized in that said glass blocks light with a wavelength shorter than 280 nm, has a transmittance of 20-30% for light with a wavelength of 280-290 nm, a transmittance of 80-90% for light with a wavelength of 290-305 nm, a transmittance of 25-35% for light with a wavelength of 305-400 nm, a transmittance of 80-90% for visible light with a wavelength of 400-780 nm, and a transmittance of 30-40% for infrared light with a wavelength of 790-2000 nm.

4. The glass according to claim 1, which efficiently transmits ultraviolet light in the 290-305 nm range and visible light while blocking other wavelengths of sunlight, characterized in that it consists of a glass substrate and a dysprosium (Dy³⁺) film layer, comprising the following steps:
(1) Preparing said glass substrate, wherein the composition of said glass substrate comprises, by weight percentage:
SiO₂: 50-70%;
B₂O₃: 10-20%;
Na₂O: 10-20%;
ZnO: 3-20%;
BaO: 5-10%;
K₂O: 1-5%;
CaO: 0.1%-1%;
Sb₂O₃: 0.1%-1%;
(2) Coating a dysprosium (Dy³⁺) film layer on the surface of the glass substrate obtained in step (1), characterized in that the thickness of said dysprosium film layer is 0.2-0.5 μm.

5. The glass according to claim 4, characterized in that said glass blocks light with a wavelength shorter than 280 nm, has a transmittance of 20-30% for light with a wavelength of 280-290 nm, a transmittance of 75-85% for light with a wavelength of 290-305 nm, a transmittance of 20-30% for light with a wavelength of 305-400 nm, a transmittance of 85-93% for visible light with a wavelength of 400-780 nm, and a transmittance of 30-40% for infrared light with a wavelength of 790-2000 nm.

6. The applications of the glass according to claim 1, which efficiently transmits ultraviolet light in the 290-305 nm range and visible light while blocking other wavelengths of sunlight, characterized in that it can be applied to residential glass windows, glass ceilings, outdoor swimming pool glass covers, solarium glass rooms, optical instruments and equipment, lighting devices, and medical apparatus and instruments that utilize ultraviolet radiation for treatment, which require selective transmission of beneficial ultraviolet and visible light that can aid in human vitamin D synthesis and health.
